(19) United States
(12) Patent Application Publication
(10) Pub. No.: US 2020/0388848 A1
(43) Pub. Date: Dec. 10, 2020

(54) ANODE FOR LITHIUM SECONDARY BATTERY AND LITHIUM SECONDARY BATTERY COMPRISING THE SAME

(71) Applicants: Hyundai Motor Company, Seoul (KR); Kia Motors Corporation, Seoul (KR)

(72) Inventor: Sang Ha Lee, Hwaseong (KR)

(21) Appl. No.: 16/788,554

(22) Filed: Feb. 12, 2020

(30) Foreign Application Priority Data
Jun. 10, 2019 (KR) 10-2019-0068206

(51) Int. Cl. H01M 4/62; H01M 4/134; H01M 4/38; H01M 4/36; H01M 10/0525

(52) U.S. Cl. CPC H01M 4/62; H01M 4/134; H01M 2004/021; H01M 4/366; H01M 10/0525; H01M 4/386

(57) ABSTRACT

The present invention relates to an anode for a lithium secondary battery and a lithium secondary battery including the same. The anode includes a fiber composite layer on an active material layer, thus exhibiting superior elasticity and resilience. As consequence, the anode for a lithium secondary battery may have no change in electrode thickness, and high ionic conductivity can be manifested, ultimately realizing a prolonged battery lifespan and superior storage capacity.

### CROSS REFERENCE TO RELATED APPLICATION

The present application claims priority based on Korean Patent Application No. 10-2019-0068206, filed on Jun. 10, 2019, the entire content of which is incorporated herein for all purposes by this reference.

### TECHNICAL FIELD

The present invention relates to an anode for a lithium secondary battery, which is configured to include a fiber composite layer on an active material layer. Thus, there is no change in electrode thickness and which also has high ionic conductivity to thus increase the lifespan of a battery.

### BACKGROUND OF THE INVENTION

A lithium secondary battery has been recently receiving attention as a power source for a small portable electronic device. The lithium secondary battery includes an organic electrolyte solution to thus exhibit a discharge voltage at least two times as high as a conventional battery using an alkaline aqueous solution, thereby manifesting high energy density. Such a lithium secondary battery has been utilized t as a power source for vehicles, but is problematic because the travel distance of vehicles is limited due to the limited energy density.

As an anode active material, various carbonaceous materials including artificial graphite, natural graphite and hard carbon, enabling the intercalation and deintercalation of lithium, have been used. Among the carbonaceous materials, graphite such as artificial graphite or natural graphite has low discharge voltage compared to lithium. A battery using graphite as an anode active material has been most widely utilized because it exhibits high discharge voltage and thus superior energy density and outstanding reversibility to thus ensure the long lifespan of a lithium secondary battery.

However, when an electrode plate is manufactured using graphite as an active material, the density of the electrode plate is lowered and thus the capacity of the electrode plate is low in terms of the energy density per unit volume, which is undesirable. Furthermore, at a high discharge voltage, a side reaction between graphite and an organic electrolyte solution is liable to occur, and there is a risk of ignition or explosion due to malfunction or overcharge of the battery.

With the goal of solving these problems, a metal-based anode active material has been developed these days. For example, amorphous tin oxide that has been developed in the related art shows a high capacity of 800 mAh/g per unit weight. In addition, silicon, which is another metal active material, has a storage capacity (3000 mAh/g) at least eight times as high as that of graphite, and silicon-based electrodes have been variously developed. However, such a metal active material repeatedly expands and decreases in volume during charging and discharging, and also has a problem of decomposition of the electrolyte.

Although the problem in which the electrolyte is decomposed is solved by applying aluminum oxide, a carbon material or the like on the surface of the metal active material, a change in the electrode thickness due to expansion and reduction of the volume of the active material remains a problem. In order to solve this problem, these days, in the related art, a method of applying a high-strength binder layer on the anode surface has been reported. The high-strength binder layer is able to transfer lithium ions and has appropriate mechanical properties, whereby the expansion of the anode plate may be efficiently controlled.

However, the lithium-ion conductivity of the polymer layer is limited, and in particular, deterioration of the battery performance may occur at low temperatures, making it impossible to serve as an automobile battery. Moreover, a bulk layer may be utilized to thus overcome the instability at the interface of the inorganic active material, but the recent use of a carbon-coated active material is capable of solving the above problem, and thus the advantage of the bulk layer is no longer present.

### SUMMARY OF THE INVENTION

In preferred aspects, provided are an anode for a lithium secondary battery, in which a fiber composite is formed on an active material layer, thereby increasing the lifespan of a battery, and a lithium secondary battery including the anode.

The objectives of the present invention are not limited to the foregoing, and will be able to be clearly understood through the following description and to be realized by the means described in the claims and combinations thereof.

In an aspect, provided is a fiber composite for a lithium secondary battery that may include a first fiber and a second fiber. The first fiber and the second fiber may be mixed such that at least a portion of the first fiber may be present in a space in the second fiber.

In an aspect, provided is an anode for a lithium secondary battery that may include a current collector, an active material layer including an anode active material, and a fiber composite layer.

The anode active material may be an oxide or a sulfide of, or an alloy of one or more selected from the group consisting of Na, K, Rb, Cs, Fr, Be, Mg, Ca, Sr, Ba, Ra, Ti, Ag, Zn, Cd, Al, Ga, In, Si, Ge, Sn, Pb, Sb, and Bi. For example, the oxide may be a compound including one or more oxygen atoms combined to one or more metal elements selected from the group consisting of Na, K, Rb, Cs, Fr, Be, Mg, Ca, Sr, Ba, Ra, Ti, Ag, Zn, Cd, Al, Ga, In, Si, Ge, Sn, Pb, Sb, and Bi. The sulfide may be a compound including one or more sulfur atoms combined to one or more metal elements selected from the group consisting of Na, K, Rb, Cs, Fr, Be, Mg, Ca, Sr, Ba, Ra, Ti, Ag, Zn, Cd, Al, Ga, In, Si, Ge, Sn, Pb, Sb, and Bi. The alloy may include one or more metallic elements combined, which may include one or more metal elements selected from the group consisting of Na, K, Rb, Cs, Fr, Be, Mg, Ca, Sr, Ba, Ra, Ti, Ag, Zn, Cd, Al, Ga, In, Si, Ge, Sn, Pb, Sb, and Bi.

The fiber composite layer may include a first fiber and a second fiber, the first fiber and the second fiber being mixed such that at least a portion of the first fiber may be present in a space in the second fiber.

The fiber composite layer may suitably include an amount of about 10 to 90 wt % of the first fiber and an amount of about 10 to 90 wt % of the second fiber based on the total weight of the fiber composite layer.

The first fiber may suitably include a polyolefinic fiber, and the second fiber may suitably include one or more selected from the group consisting of glass fiber, cellulose fiber, polyamide fiber, polyester fiber, polyacrylonitrile fiber, and polyvinylidene fluoride fiber.

The first fiber may have an average diameter of about 0.01 μm to 20 μm and an average length of about 50 μm to 10,000 μm, and the second fiber may have an average diameter of about 0.01 μm to 20 μm and an average length of about 50 μm to 10,000 μm.

The fiber composite layer may suitably include a first fiber and a filler, the first fiber and the filler being mixed such that at least a portion of the filler may be present in a space in the first fiber.

The fiber composite layer may suitably include an amount of about 10 to 90 wt % of the first fiber and an amount of about 10 to 90 wt % of the filler based on the total weight of the fiber composite layer.

The first fiber may suitably include a polyolefinic fiber, and the filler may suitably include one or more selected from the group consisting of alumina, silica, zirconia, and titania.

The first fiber may have an average diameter of about 0.01 μm to 20 μm and an average length of about 50 μm to 10,000 μm, and the filler may have an average particle diameter of about 0.1 μm to 100 μm.

The fiber composite layer may include a first fiber and a third fiber resulting from subjecting the surface of the first fiber to hydrophilic treatment, the first fiber and the third fiber being mixed such that at least a portion of the first fiber may be present in a space in the third fiber.

The fiber composite layer may suitably include an amount of about 10 to 90 wt % of the first fiber and an amount of about 10 to 90 wt % of the third fiber based on the total weight of the fiber composite layer.

The first fiber may suitably include a polyolefinic fiber, and the third fiber may suitably include a hydrophilic polymer. For example, the third fiber may be obtained by treating the surface of the first fiber with the hydrophilic polymer.

The first fiber may have an average diameter of about 0.01 μm to 20 μm and an average length of about 50 μm to 10,000 μm.

The fiber composite layer may have a thickness of about 1 to 500 μm and a porosity of about 85 to 95%.

Further provided is a lithium secondary battery including a cathode and the anode as described herein.

Still further provided are vehicles that comprise a lithium secondary battery as disclosed herein.

According to various exemplary embodiments of the present invention, an anode for a lithium secondary battery may include a fiber composite layer, thus exhibiting superior elasticity and resilience due to the presence of a sufficient number of voids despite expansion and reduction of the volume of an active material layer during charging and discharging, whereby there is no change in electrode thickness, and high ionic conductivity can be manifested, ultimately realizing a prolonged battery lifespan.

Further, according to various exemplary embodiments of the present invention, a lithium secondary battery may include a metal-based anode active material, in lieu of an existing graphite-based anode active material, thereby increasing storage capacity. Moreover, the battery weight can be reduced compared to the weight of a conventional battery even when the anode including the fiber composite layer is used.

The effects of the present invention are not limited to the foregoing, and should be understood to include all effects that can be reasonably anticipated based on the following description.

Other aspects of the invention are disclosed infra.

### BRIEF DESCRIPTION OF DRAWINGS

FIG. 1 is a cross-sectional view showing a conventional lithium secondary battery;

FIG. 2 shows an exemplary fiber composite layer of an exemplary anode for an exemplary lithium secondary battery according to an exemplary embodiment of the present invention;

FIG. 3 shows an exemplary fiber composite layer of an exemplary anode for an exemplary lithium secondary battery according to an exemplary embodiment of the present invention;

FIG. 4 shows an exemplary fiber composite layer of an exemplary anode for an exemplary lithium secondary battery according to an exemplary embodiment of the present invention;

FIG. 5 is a cross-sectional view showing exemplary lithium secondary battery according to an exemplary embodiment of the present invention;

FIG. 6A is a cross-sectional view showing shrinkage of the fiber composite layer upon expansion of an exemplary anode of an exemplary lithium secondary battery according to an exemplary embodiment of the present invention;

FIG. 6B is a cross-sectional view showing expansion of an exemplary fiber composite layer upon shrinkage of an exemplary anode of an exemplary lithium secondary battery according to an exemplary embodiment of the present invention; and

FIG. 7 is a scanning electron microscope (SEM) image showing the cross-section of an exemplary anode of an exemplary lithium secondary battery according to an exemplary embodiment of the present invention.

### DETAILED DESCRIPTION

The above and other objectives, features and advantages of the present invention will be more clearly understood from the following preferred embodiments taken in conjunction with the accompanying drawings. However, the present invention is not limited to the embodiments disclosed herein, and may be modified into different forms. These embodiments are provided to thoroughly explain the invention and to sufficiently transfer the spirit of the present invention to those skilled in the art.

Throughout the drawings, the same reference numerals will refer to the same or like elements. For the sake of clarity of the present invention, the dimensions of structures are depicted as being larger than the actual sizes thereof. It will be understood that, although terms such as “first”, “second”, etc. may be used herein to describe various elements, these elements are not to be limited by these terms. These terms are only used to distinguish one element from another element. For instance, a “first” element discussed below could be termed a “second” element without departing from the scope of the present invention. Similarly, the “second” element could also be termed a “first” element. As used herein, the singular forms are intended to include the plural forms as well, unless the context clearly indicates otherwise.

It will be further understood that the terms “comprise”, “include”, “have”, etc., when used in this specification, specify the presence of stated features, integers, steps, operations, elements, components, or combinations thereof, but do not preclude the presence or addition of one or more other features, integers, steps, operations, elements, components, or combinations thereof. Also, it will be understood that when an element such as a layer, film, area, or sheet is referred to as being “on” another element, it can be directly on the other element, or intervening elements may be present therebetween. Similarly, when an element such as a layer, film, area, or sheet is referred to as being “under” another element, it can be directly under the other element, or intervening elements may be present therebetween.

Unless otherwise specified, all numbers, values, and/or representations that express the amounts of components, reaction conditions, polymer compositions, and mixtures used herein are to be taken as approximations including various uncertainties affecting the measurements that essentially occur in obtaining these values, among others, and thus should be understood to be modified by the term “about” in all cases. Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Furthermore, when a numerical range is disclosed in this specification, the range is continuous, and includes all values from the minimum value of said range to the maximum value thereof, unless otherwise indicated. Moreover, when such a range pertains to integer values, all integers including the minimum value to the maximum value are included, unless otherwise indicated.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Hereinafter, a detailed description will be given of an embodiment of the present invention.

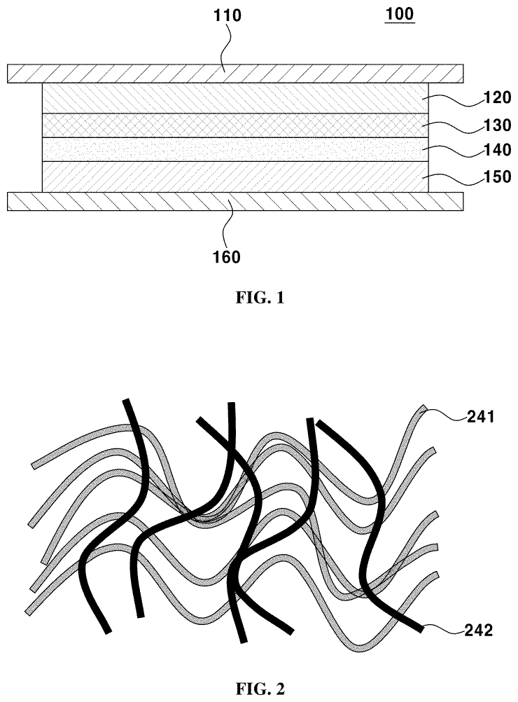

FIG. 1 is a cross-sectional view showing a conventional lithium secondary battery 100. The conventional lithium secondary battery 100 is configured such that a current collector 160, an anode active material layer 150, a polymer matrix 140, a separator membrane 130, a cathode 120 and a cathode current collector 110 are sequentially stacked. The polymer matrix 140, which is located between the anode active material layer 150 and the separator membrane 130, has an appropriate elastic modulus and may thus control the expansion of the anode active material layer 150. When the polymer matrix 140 is applied to the lithium secondary battery 100, changes in the volume of the anode active material may be suppressed to thereby increase the lifespan of a battery. However, the polymer matrix 140, having very low lithium-ion conductivity, may cause the performance of a battery to deteriorate, which is undesirable.

In order to solve the above problems in the present invention, an anode including a fiber composite layer 240 may be manufactured, thus exhibiting superior elasticity and resilience due to the presence of a sufficient number of voids despite expansion and reduction of the volume of the active material layer 250 during charging and discharging, whereby there is no change in electrode thickness, ultimately increasing the lifespan of the battery. Moreover, storage capacity, rate characteristics and low-temperature characteristics may be improved because of high ionic conductivity. Furthermore, the use of a metal-based active material, in lieu of a conventional graphite-based active material, is capable of increasing storage capacity at least five times, and a weight reduction of 40% or more may be achieved compared to existing anodes even when the fiber composite layer 240 is included.

In one aspect, provided are an anode for a lithium secondary battery and a lithium secondary battery 200 including the same. The anode for a lithium secondary battery according to an exemplary embodiment of the present invention may include a current collector 260, an active material layer 250 including an anode active material, and a fiber composite layer 240. The fiber composite may include a first fiber and a second fiber, the first fiber and the second fiber being mixed such that at least a portion of the first fiber may be present in a space in the second fiber.

The current collector 260 may function as an electron transfer path, and the current collector 260 may suitably include one or more selected from the group consisting of copper, nickel, stainless steel, molybdenum, tungsten, and tantalum.

The active material layer 250 may be located on the current collector 260, and may include an anode active material. The anode active material may suitably include an oxide or sulfide of one or more selected from the group consisting of Na, K, Rb, Cs, Fr, Be, Mg, Ca, Sr, Ba, Ra, Ti, Ag, Zn, Cd, Al, Ga, In, Si, Ge, Sn, Pb, Sb, and Bi. Alternatively, the anode active material may suitably include an alloy of one or more selected from the group consisting of Na, K, Rb, Cs, Fr, Be, Mg, Ca, Sr, Ba, Ra, Ti, Ag, Zn, Cd, Al, Ga, In, Si, Ge, Sn, Pb, Sb, and Bi. The anode active material has the advantage of increasing the lifespan of the battery by accommodating or compensating for changes in the volume of the anode active material during charging and discharging, unlike existing graphite.

The fiber composite layer 240 may include a first fiber 241 and a second fiber 242, the first fiber 241 and the second fiber 242 being mixed such that at least a portion of the first fiber 241 may be present in a space in the second fiber 242.

FIG. 2 shows an exemplary fiber composite layer 240 of an exemplary anode for an exemplary lithium secondary battery according to an exemplary embodiment of the present invention. The fiber composite layer 240 may contain therein a sufficient number of voids having a porous structure by mixing the first fiber 241 and the second fiber 242. In particular, the fiber composite layer 240 may suitably include the first fiber 241, having superior elasticity and resilience, and the second fiber 242, having high ionic conductivity and superior mechanical properties such as rigidity, thus exhibiting synergistic effects between the two kinds of fiber. Also, by virtue of the voids in the fiber composite layer 240, the volume may elastically change, and simultaneously the transfer of the electrolyte is not impeded. By the use of the material having high ionic conductivity, the lifespan of the battery may be increased and low-temperature characteristics may be prevented from deteriorating.

The fiber composite layer 240 may suitably include an amount of about 10 to 90 wt % of the first fiber 241 and an amount of about 10 to 90 wt % of the second fiber 242 based on the total weight of the fiber composite layer. When the amount of the first fiber 241 is less than about 10 wt %, poor elasticity may result. On the other hand, when the amount of the first fiber 241 is greater than about 90 wt %, ionic conductivity and mechanical properties may deteriorate. When the amount of the second fiber 242 is less than about 10 wt %, ionic conductivity may become poor and rigidity may deteriorate. On the other hand, when the amount of the second fiber 242 is greater than about 90 wt %, elasticity and resilience may deteriorate. Preferably, the fiber composite layer 240 suitably include an amount of about 30 to 70 wt % of the first fiber 241 and an amount of about 30 to 70 wt % of the second fiber 242 based on the total weight of the fiber composite layer.

The first fiber 241 may suitably include a material having superior elasticity and resilience. The first fiber 241 may suitably include a polyolefinic fiber. Preferably, the polyolefinic fiber may be a polymer that includes one or more carbon-carbon unsaturated bonds such as double bonds in a repeat unit or otherwise along the polymer chain or side chain. Exemplary suitable polyolefinic filers include but not limited to, one or more selected from the group consisting of polyethylene fiber, and polyvinylidene fluoride fiber.

The second fiber 242 may suitably include a material having high ionic conductivity and superior mechanical properties such as rigidity. Also, the second fiber 242 may suitably include a material imparted with a hydrophilic surface through plasma treatment. The second fiber 242 may suitably include one or more selected from the group consisting of glass fiber, cellulose fiber, polyamide fiber, polyester fiber, polyacrylonitrile fiber, and polyvinylidene fluoride fiber, among others.

The first fiber 241 suitably may have an average diameter of about 0.01 μm to 20 μm and an average length of about 50 μm to 10,000 μm, and the second fiber 242 may have an average diameter of about 0.01 μm to 20 μm and an average length of about 50 μm to 10,000 μm. When the diameter of the first fiber 241 or the second fiber 242 is less than about 0.01 μm, the voids in the composite layer may be small, and thus ionic conductivity may decrease. On the other hand, when the diameter of the first fiber 241 or the second fiber 242 is greater than about 20 μm, the surface roughness of the composite layer may increase, and thus damage to the electrode surface may occur. Also, when the length of the first fiber 241 or the second fiber 242 is less than about 50 μm, the mechanical properties of the composite layer may deteriorate. On the other hand, when the length of the first fiber 241 or the second fiber 242 is greater than about 10,000 μm, the fiber may easily become entangled, making it difficult to form a uniform composite layer.

The fiber composite layer 240 may suitably include a first fiber 241 and a filler 243, the first fiber 241 and the filler 243 being mixed such that at least a portion of the filler 243 may be present in a space in the first fiber 241.

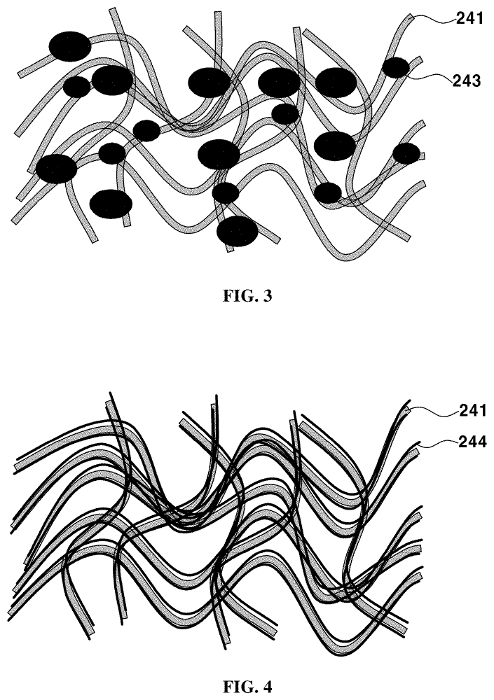

FIG. 3 shows an exemplary fiber composite layer 240 of an exemplary anode for an exemplary lithium secondary battery according to an exemplary embodiment of the present invention. Voids having a porous structure may be formed by mixing the filler 243 in a spherical particle phase in the first fiber 241. The fiber composite layer 240 is configured such that the filler 243 in a spherical particle phase having high ionic conductivity and superior mechanical properties may be incorporated in the first fiber 241, having superior elasticity and resilience, thereby exhibiting synergistic effects with superior elasticity and mechanical properties.

The fiber composite layer 240 may suitably include an amount of about 10 to 90 wt % of the first fiber 241 and an amount of about 10 to 90 wt % of the filler 243 based on the total weight of the fiber composite layer. Here, when the amount of the filler 243 is less than about 10 wt %, ionic conductivity and mechanical properties may deteriorate. On the other hand, when the amount of the filler 243 is greater than about 90 wt %, elasticity and resilience may deteriorate. Preferably, the fiber composite layer 240 may suitably include an amount of about 30 to 70 wt % of the first fiber 241 and an amount of about 30 to 70 wt % of the filler 243 based on the total weight of the fiber composite layer.

The first fiber 241 may suitably include a polyolefinic fiber. Preferably, the polyolefinic fiber may include one or more selected from the group consisting of polyethylene fiber, and polyvinylidene fluoride fiber.

The filler 243 may suitably include a material having hydrophilicity and thus high ionic conductivity and superior mechanical properties. The filler 243 may suitably include one or more selected from the group consisting of alumina, silica, zirconia, and titania.

The first fiber 241 may have an average diameter of about 0.01 μm to 20 μm and a length of about 50 μm to 10,000 μm, and the filler 243 may have an average particle diameter of about 0.1 μm to 100 μm. When the average particle diameter of the filler 243 is less than about 0.1 μm, the size of the voids in the composite layer may decrease, undesirably lowering ionic conductivity. On the other hand, when the average particle diameter of the filler 243 is greater than about 100 μm, the uniformity of the composite layer may decrease.

The fiber composite layer 240 may suitably include a first fiber 241 and a third fiber 244 resulting from subjecting the surface of the first fiber 241 to hydrophilic treatment, the first fiber 241 and the third fiber 244 being mixed such that at least a portion of the first fiber 241 may be present in a space in the third fiber 244.

FIG. 4 shows an exemplary fiber composite layer 240 of an exemplary anode for an exemplary lithium secondary battery according to an exemplary embodiment of the present invention. The first fiber 241 and the third fiber 244 may be mixed while forming voids therebetween. In particular, the fiber composite layer 240 may suitably include the first fiber 241, having superior elasticity and resilience, and the third fiber 244, resulting from subjecting the surface of the first fiber 241 to hydrophilic treatment, thereby increasing ionic conductivity.

The fiber composite layer 240 may suitably include an amount of about 10 to 90 wt % of the first fiber 241 and an amount of about 10 to 90 wt % of the third fiber 244 based on the total weight of the fiber composite layer. In particular, when the amount of the third fiber 244 is less than about 10 wt %, ionic conductivity may decrease. On the other hand, when the amount of the third fiber 244 is greater than about 90 wt %, mechanical properties may deteriorate. Preferably, the fiber composite layer 240 may include an amount of about 30 to 70 wt % of the first fiber 241 and an amount of about 30 to 70 wt % of the third fiber 244 based on the total weight of the fiber composite layer.

The first fiber 241 may suitably include a polyolefinic fiber. Preferably, the polyolefinic fiber may include one or more selected from the group consisting of polyethylene fiber, and polyvinylidene fluoride fiber.

The third fiber 244 may suitably include a hydrophilic polymer. For example, the third fiber 244 may be obtained by treating the surface of the first fiber 241 with a hydrophilic polymer through plasma treatment. Since the third fiber 244 is obtained through hydrophilic treatment of the surface of the first fiber 241, ionic conductivity may be effectively increased.

The first fiber 241 may have an average diameter of about 0.01 μm to 20 μm and an average length of about 50 μm to 10,000 μm.

The fiber composite layer 240 may have a thickness of about 1 to 500 μm and a porosity of about 85 to 95%. When the thickness of the fiber composite layer 240 is less than about 1 μm, the effect of increasing the lifespan of a battery may become insignificant. On the other hand, when the thickness thereof is greater than about 500 μm, the resistance of the battery may increase, and the use of the battery with an increase in the electrode thickness may become difficult. Also, when changes in the thickness of the fiber composite layer 240 are compared 30 sec after depressurization after applying a pressure of 30 kPa, resilience of about 70% or greater may be exhibited. Here, when the resilience of the fiber composite layer 240 is less than about 70%, the effect of increasing the lifespan of a battery may become insignificant.

In addition, the present invention pertains to a lithium secondary battery 200, including a cathode 220 and an anode.

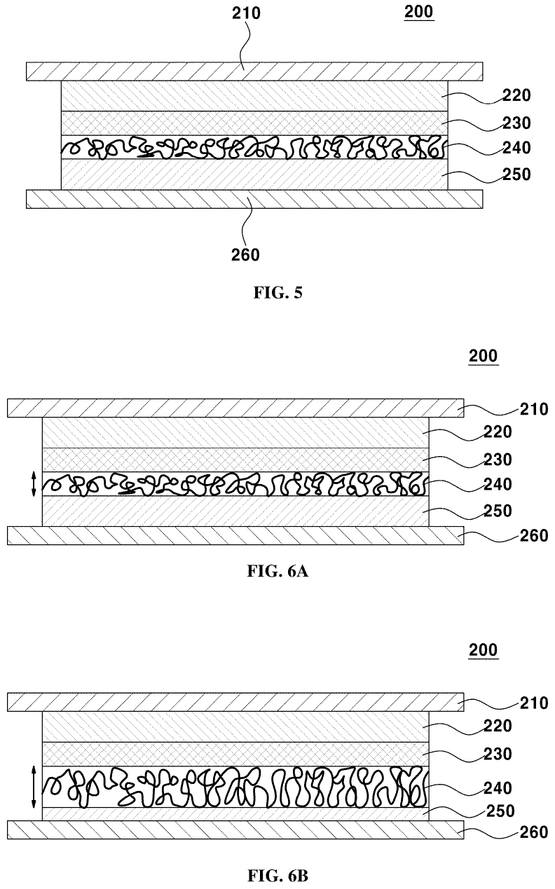

FIG. 5 is a cross-sectional view showing an exemplary lithium secondary battery 200 according to an exemplary embodiment of the present invention. With reference to FIG. 5, the anode is configured such that a current collector 260, an active material layer 250 and a fiber composite layer 240 are sequentially formed. A separator membrane 230 may be formed on the fiber composite layer 240, and the cathode 220 may be formed on the separator membrane.

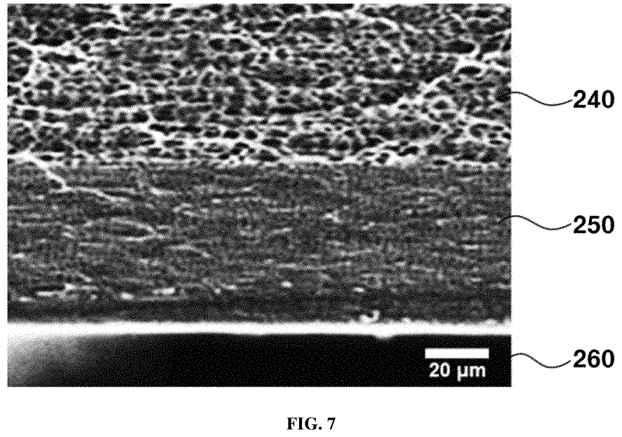

FIG. 6A is a cross-sectional view showing the shrinkage of an exemplary fiber composite layer 240 upon expansion of an exemplary anode of an exemplary lithium secondary battery 200 according to an exemplary embodiment of the present invention. As shown in FIG. 6A, when the anode active material of the active material layer 250 is charged and thus expands, the fiber composite layer 240 may shrink in proportion thereto, whereby the stress applied to the separator membrane 230 and the cathode 220 may be relieved.

FIG. 6B is a cross-sectional view showing the expansion of an exemplary fiber composite layer 240 upon shrinkage of an exemplary anode of an exemplary lithium secondary battery 200 according to an exemplary embodiment of the present invention. As shown in FIG. 6B, when the anode active material of the active material layer 250 is discharged and thus shrinks, the fiber composite layer 240 may expand in proportion thereto, whereby the thickness of the battery may be maintained constant and the ion transfer may become efficient, ultimately increasing the lifespan of the battery.

### EXAMPLE

A better understanding of the present invention will be given through the following examples, which are not to be construed as limiting the present invention.

### Example 1

Copper (foil) was used as an anode current collector and an active material layer was composed of a mixture of silicon having a particle diameter of 100 nm as an anode active material, a polyvinyl alcohol (PVA) binder and a Super P conductor at a weight ratio of 80:10:10. A fiber composite mixture was composed of 30 w % of polyethylene (PE) fiber as a first fiber 241 and 70 wt % of glass fiber as a second fiber. Here, the first fiber 241 had a fiber average diameter of 1 μm and a fiber average length of 100 μm. The second fiber had a fiber average diameter of 5 μm and a fiber average length of 1000 μm.

As a cathode current collector, aluminum (foil) was used, a cathode was lithium metal, and a separator membrane was configured such that a porous polymer membrane was impregnated with an electrolyte. Here, in the separator membrane, the porous polymer membrane was polypropylene (PP) and the electrolyte was a 1 M LiPF₆-containing mixed solution comprising ethylene carbonate (EC), diethyl carbonate (DEC) and dimethyl carbonate (DMC) mixed at a weight ratio of 1:1:1.

The active material slurry was applied on the anode current collector and thermally treated, thus forming an active material layer. Next, the fiber composite mixture was applied on the active material layer and then dried at a temperature of 80° C., thus manufacturing an anode having the fiber composite layer. Here, the fiber composite layer had a thickness of 100 μm and a porosity of 90%. Next, the separator membrane and the cathode were sequentially stacked on the fiber composite layer of the anode, thereby manufacturing a 2032-coin-cell-type lithium secondary battery.

FIG. 7 is a SEM image showing the cross-section of an exemplary anode of an exemplary lithium secondary battery. The anode was configured such that the current collector 260, the active material layer 250 and the fiber composite layer 240 were sequentially formed.

Examples 2 to 4 and Comparative Examples 1 to 4 Respective lithium secondary batteries were manufactured in the same manner as in Example 1, with the exception that the anode active material and the fiber composite layer of the anode were formed using components shown in Table 1 below.

### Test Example

The lithium secondary battery of each of Examples 1 to 4 and Comparative Examples 1 to 4 was measured for discharge capacity at 0.2C and 2C current rates and for discharge capacity maintenance rate after 100 charge/discharge cycles. The results are shown in Table 1 below.

In Table 1, 0.2C designates the current rate when the battery was completely discharged for 5 hr, and 2C designates the current rate when the battery was completely discharged for 0.5 hr.

TABLE 1

| | | | | | | Discharge capacity |
|---|---|---|---|---|---|---|
| | | Anode | | Discharge | Discharge | maintenance rate after 100 |
| | | active | Fiber composite | capacity at | capacity at | charge/discharge cycles |
| No. | | material | layer | 0.2C | 2C | (%) |
| Comparative | 1 | Graphite | — | 368 | 289 | 94 |
| Example | 2 | Silicon | — | 2514 | 1858 | 38 |
| | 3 | Silicon | PE fiber layer | 2134 | 791 | 79 |
| | 4 | Silicon | Glass fiber layer | 2546 | 1857 | 47 |
| Example | 1 | Silicon | PE fiber:glass | 2522 | 1853 | 89 |
| | | | fiber | | | |
| | | | (30:70 wt %) | | | |
| | 2 | Silicon | PE fiber:glass | | | |
| | | | fiber | 2310 | 1214 | 92 |
| | | | (70:30 wt %) | | | |

As is apparent from the results of Table 1, Examples 1 to 4 included the fiber composite layer including the first fiber having superior elasticity and resilience and the second fiber having high ionic conductivity and rigidity, the discharge capacities at both 0.2C and 2C exhibited high results. Also, the discharge capacity maintenance rate after 100 charge/discharge cycles was high to the level of 89% or more, indicating that the lifespan of the battery was increased.

In contrast, in Comparative Example 1, graphite was used as the anode active material and the fiber composite layer was not included, and thus there was a small change in electrode volume, whereby the discharge capacity maintenance rate after 100 charge/discharge cycles was high but the discharge capacities at 0.2C and 2C were very low due to the low discharge capacity of graphite.

In Comparative Example 2, silicon was used as the anode active material and the fiber composite layer was not included, and thus there was a severe change in the thickness of the battery, whereby the discharge capacity maintenance rate after 100 charge/discharge cycles was greatly decreased.

In Comparative Example 3, the single PE fiber layer was included and silicon was used, and thus the discharge capacity at 0.2C and the discharge capacity maintenance rate after 100 charge/discharge cycles were improved, but the discharge capacity at 2C was deteriorated due to low ionic conductivity.

In Comparative Example 4 using the single glass fiber layer, the ionic conductivity was not decreased and thus the discharge capacities at 0.2C and 2C were high but there was a severe change in the thickness of the battery due to the low elasticity and resilience of the glass fiber layer, whereby the discharge capacity maintenance rate after 100 charge/discharge cycles was greatly decreased.

Although the preferred embodiments of the present invention have been disclosed for illustrative purposes, those skilled in the art will appreciate that various modifications are possible without departing from the scope and spirit of the invention as disclosed in the accompanying claims, and such modifications should not be understood separately from the technical ideas or essential characteristics of the present invention.

What is claimed is:

1. A fiber composite for a lithium secondary battery, comprising:
a first fiber and a second fiber,
the first fiber and the second fiber being mixed such that at least a portion of the first fiber is present in a space in the second fiber.

2. An anode for a lithium secondary battery, comprising:
a current collector;
an active material layer including an anode active material; and
a fiber composite layer comprising a fiber composite.

3. The anode of claim 2, wherein the anode active material comprises an oxide or a sulfide of, or an alloy comprising one or more selected from the group consisting of Na, K, Rb, Cs, Fr, Be, Mg, Ca, Sr, Ba, Ra, Ti, Ag, Zn, Cd, Al, Ga, In, Si, Ge, Sn, Pb, Sb, and Bi.

4. The anode of claim 2, wherein the fiber composite layer comprises a first fiber and a second fiber,
the first fiber and the second fiber being mixed such that at least a portion of the first fiber is present in a space in the second fiber.

5. The anode of claim 4, wherein the fiber composite layer comprises an amount of about 10 to 90 wt % of the first fiber and an amount of about 10 to 90 wt % of the second fiber based on the total weight of the fiber composite layer.

6. The anode of claim 4, wherein the first fiber comprises a polyolefinic fiber, and
the second fiber comprises one or more selected from the group consisting of glass fiber, cellulose fiber, polyamide fiber, polyester fiber, polyacrylonitrile fiber, and polyvinylidene fluoride fiber.

7. The anode of claim 4, wherein the first fiber has an average diameter of about 0.01 μm to 20 μm and an average length of about 50 μm to 10,000 μm, and
the second fiber has an average diameter of about 0.01 μm to 20 μm and an average length of about 50 μm to 10,000 μm.

8. The anode of claim 2, wherein the fiber composite layer comprises a first fiber and a filler,
the first fiber and the filler being mixed such that at least a portion of the filler is present in a space in the first fiber.

9. The anode of claim 8, wherein the fiber composite layer comprises an amount of about 10 to 90 wt % of the first fiber and an amount of about 10 to 90 wt % of the filler based on the total weight of the fiber composite layer.

10. The anode of claim 8, wherein the first fiber comprises a polyolefinic fiber, and
the filler comprises one or more selected from the group consisting of alumina, silica, zirconia, and titania.

11. The anode of claim 8, wherein the first fiber has an average diameter of about 0.01 μm to 20 μm and an average length of about 50 μm to 10,000 μm, and
the filler has an average particle diameter of about 0.1 μm to 100 μm.

12. The anode of claim 2, wherein the fiber composite layer comprises a first fiber and a third fiber resulting from subjecting a surface of the first fiber to hydrophilic treatment,
the first fiber and the third fiber being mixed such that at least a portion of the first fiber is present in a space in the third fiber.

13. The anode of claim 12, wherein the fiber composite layer comprises an amount of about 10 to 90 wt % of the first fiber and an amount of about 10 to 90 wt % of the third fiber based on the total weight of the fiber composite layer.

14. The anode of claim 12, wherein the first fiber comprises a polyolefinic fiber, and
the third fiber comprises a hydrophilic polymer.

15. The anode of claim 14, wherein the third fiber is obtained by treating a surface of the first fiber with the hydrophilic polymer.

16. The anode of claim 12, wherein the first fiber has an average diameter of about 0.01 μm to 20 μm and an average length of about 50 μm to 10,000 μm.

17. The anode of claim 2, wherein the fiber composite layer has a thickness of about 1 to 500 μm and a porosity of about 85 to 95%.

18. A lithium secondary battery, comprising:
a cathode; and
the anode of claim 2.

19. A vehicle comprising a lithium secondary battery of claim 18
